(19) United States
(12) Patent Application Publication
(10) Pub. No.: US 2013/0099709 A1
(43) Pub. Date: Apr. 25, 2013

(54) Circuit Protection Method and Motor Control Circuit

(71) Applicants: Ming-Jung Tsai, Hsinchu City (TW); Kun-Min Chen, Changhua County (TW); Ching-Sheng Li, Hsinchu County (TW)

(72) Inventors: Ming-Jung Tsai, Hsinchu City (TW); Kun-Min Chen, Changhua County (TW); Ching-Sheng Li, Hsinchu County (TW)

(21) Appl. No.: 13/323,829

(22) Filed: Dec. 13, 2011

(30) Foreign Application Priority Data
Oct. 19, 2011 (TW) 100137855

(51) Int. Cl. H02P 7/00

(52) U.S. Cl. 318/434

(57) ABSTRACT

A circuit protection method for a motor control circuit includes determining whether the motor control circuit complies with an operating condition when the motor control circuit is in a start mode, a lock mode or a restart mode, and modulating a current outputted from the motor control circuit when the motor control circuit complies with the operating condition.

### BACKGROUND OF THE INVENTION

1. Field of the Invention

The present invention relates to a circuit protection method and a motor control circuit, and more particularly, to a circuit protection method and a motor control circuit for preventing the motor from generating an over current.

2. Description of the Prior Art

A motor is an electronic device for transferring electrical energy into dynamic energy, such as a DC motor, an AC motor or a stepper motor, etc. The DC motor is frequently utilized in non-sophisticated control devices, such as for a Computer Process Unit inside a computer or for an optical disc drive. Generally, the DC motor rotates based on a current passing through coils of a rotor of the DC motor to generate different amounts or a polarized direction of magnetic force, so as to attract or repel a permanent magnet on a stator of the DC motor to make the motor rotate.

In many practical motor examples, the technique of pulse width modulation is frequently utilized for modulating the current passing through the motors, so as to save the electrical power as well as to control rotational speed. The technique of pulse width modulation is a means of adjusting a period ratio of a power supply transferring energy to a load (e.g. the DC motor) within a periodical square wave, and the period ratio between the periods of transferring energy to the load versus a periodicity of the square wave is called a duty cycle. When the duty cycle equals 1, this means that the power supply transfers nearly full energy to the load; otherwise, when the duty cycle equals 0, this means that the power supply transfers barely any energy to the load.

Please refer to FIG. 1, which illustrates a schematic diagram of a motor control circuit 10 of the prior art. The motor control circuit 10 includes a power supply 100, a control module 102, a comparator 104, a bridge circuit 106 and a motor 108. The bridge circuit 106 includes four switches SW1, SW2, SW3 and SW4, wherein the switches SW1 and SW3 are called an up-bridge circuit and the switches SW2 and SW4 are called a down-bridge circuit. The motor 108 is coupled between two output ports OUT1 and OUT2 of the bridge circuit 106. The motor control circuit 10 further includes by-pass capacitors CVM1 and CVCC1 for voltage stabilization and a detect resistor RS1 for detecting current passing through the motor 108. According to voltage differences between two terminals VCC1 and VM1, it is easy to calculate the current passing through the motor 108, and to control the current outputted from the motor control circuit 10 via the control module 102 controlling the up-bridge circuit SW1, SW3 and the down-bridge circuit SW2, SW4 to turn on or off.

Please refer to FIG. 2, which illustrates another schematic diagram of a motor control circuit 20 of the prior art. The motor control circuit 20 in FIG. 2 is similar to the motor control circuit 10 in FIG. 1, and those elements with similar functions are represented by the same symbols. The only Different is that the motor control circuit 20 detects the current passing through the motor 108 via a detect resistor RS2, two division voltage resistors RD1 and RD2, and a comparator 204. In the motor control circuit 20, the detect resistor RS2 connects between the down-bridge circuit SW2, SW4 and the ground GND. Therefore, all the current passing through the motor 108 will pass the detect resistor RS2. In comparison with the motor control circuit 10, the motor control circuit 20 detects the current more precisely. A voltage VSTD is transformed into a fixed voltage VLIM according to a ratio of the division voltage resistors RD1 and RD2 to be transferred to an input port of the comparator 204. A terminal voltage VSS of the detect resistor RS2 is transferred to another input port of the comparator 204. After the comparator 204 compares the voltage differences between the two input ports, a signal is outputted to the control module 102 and which then modulates the current outputted from the motor control circuit 20.

In comparison with the motor control circuit 10 in FIG. 1, the motor control circuit 20 in FIG. 2 avoids interference of the by-pass capacitor CVM1 and increases detection accuracy of the detect resistor RS2. However, the detect resistor RS2 must be a sophisticated resistor which can suffer from a high input power, which will increase the production costs as well as extra power consumption. If users are forced to choose a smaller resistance of the detect resistor RS2 in order to reduce extra power consumption, the voltage differences between two terminals of the detect resistor RS2 will be small, which adds a necessity to install extra circuits for increasing detection accuracy. Under these circumstances, the motor control circuit 20 still needs an improvement in accuracy detection.

### SUMMARY OF THE INVENTION

It is therefore an objective of the present invention to provide a circuit protection method and a motor control circuit.

A circuit protection method is utilized for a motor control circuit. The circuit protection method includes determining whether the motor control circuit complies with an operating condition when the motor control circuit is in a start mode, a lock mode or a restart mode; and modulating a current outputted from the motor control circuit when the motor control circuit complies with the operating condition.

A motor control circuit is utilized for determining whether the motor control circuit complies with an operating condition when the motor control circuit is in a start mode, a lock mode or a restart mode. The motor control circuit includes a detect module coupled to a motor for detecting a current outputted from the motor control circuit and modulating a current outputted from the motor control circuit when the motor control circuit complies with the operating condition, a bridge circuit coupled to an output port of the detect module, and a pulse width modulation source coupled to an input port of the detect module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a motor control circuit of the prior art.

FIG. 2 illustrates another schematic diagram of a motor control circuit of the prior art.

FIG. 3 illustrates a schematic diagram of a motor control circuit of the present invention.

FIG. 4 illustrates a flow chat of a protection circuit process of the present invention.

FIG. 5 illustrates a timing diagram of the motor control circuit of the present invention.

FIG. 6 illustrates another flow chat of a protection circuit process of the present invention.

### DETAILED DESCRIPTION

Prior to the present invention, the applicant has applied to the Taiwan Intellectual Property Office with another invention having Application No. 098109619 on 2009 Mar. 24, and named “Current Limit Control Method of DC Motor and Related Device and Circuit”, which discloses a method and circuit for a limited current passing through a DC motor. However, those related circuits have complex circuit designs and limit lots of conditions in the semiconductor process, which leads to a limited application field of the motor control circuit. Furthermore, the only thing users care about is that whether or not the motor control circuit can effectively modulate an output current, to prevent an over current passing through the motor and burn down the motor. There are few people who really care about the exactly amount of current passing through the motor. Thus, the applicant of the present invention further provides another circuit protection method and its related circuit for the motor control circuit to avoid complex circuit designs and expansive semiconductor process, and to increase applied fields of the motor control circuit.

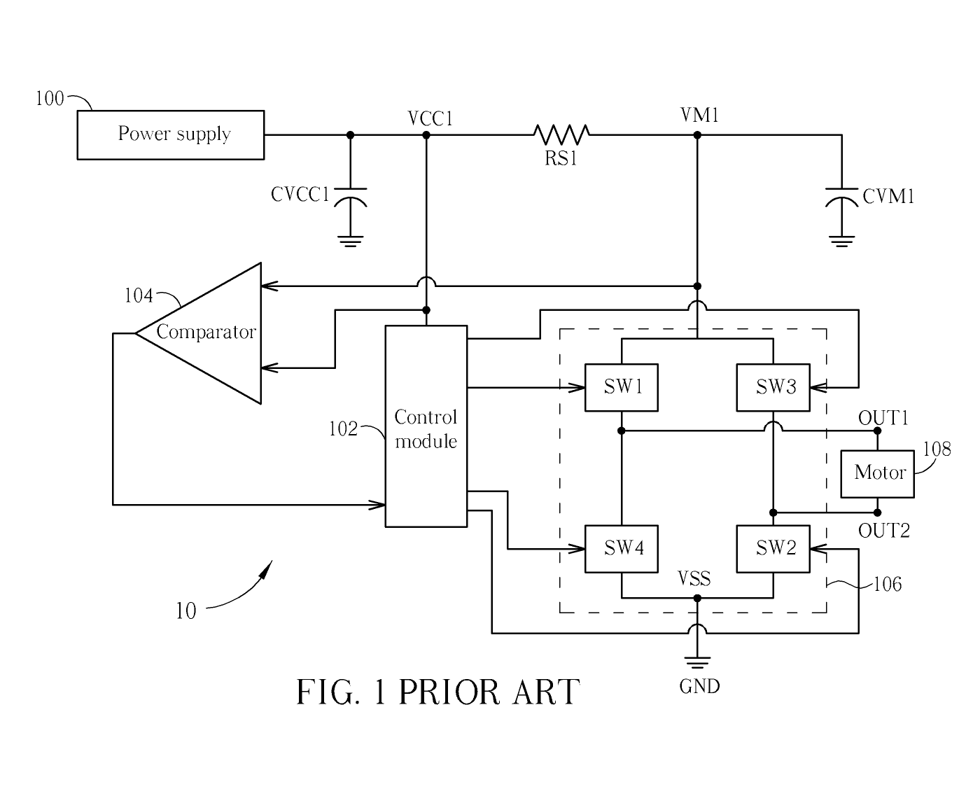

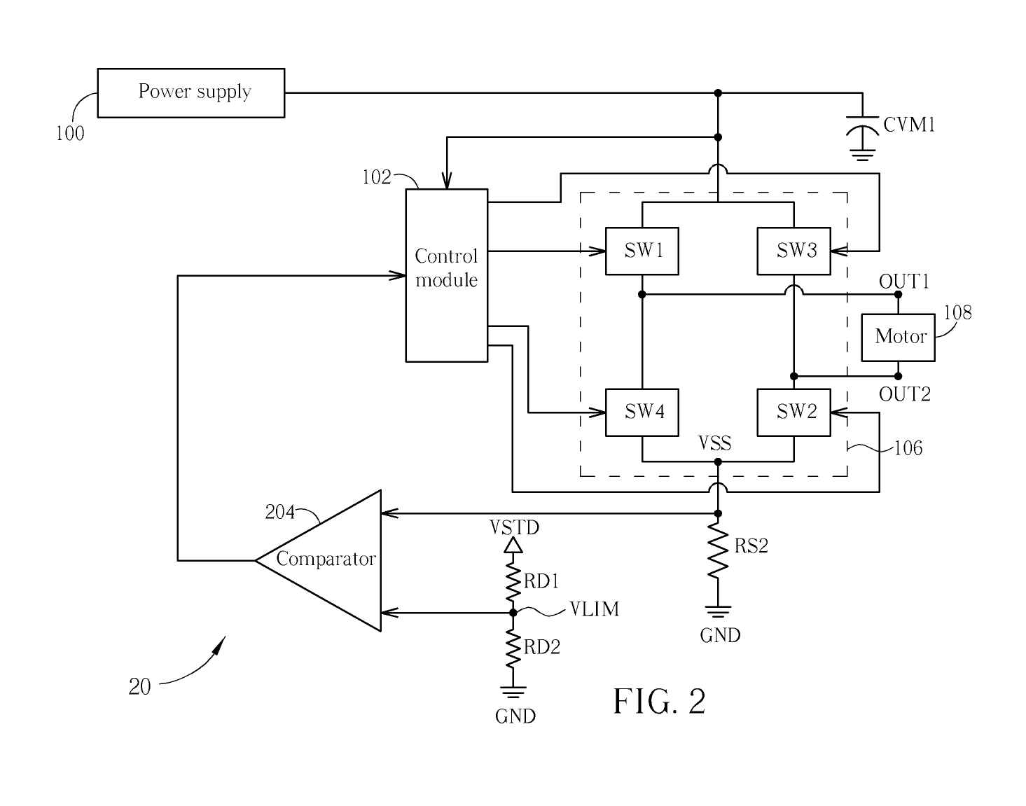

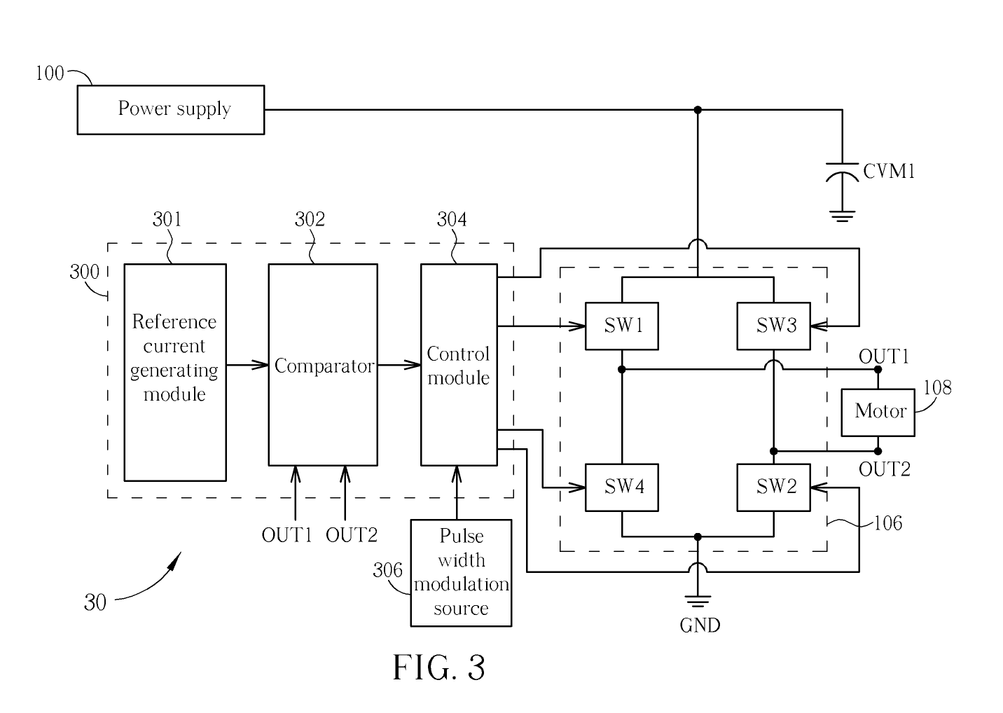

Please refer to FIG. 3, which illustrates a schematic diagram of a motor control circuit 30 of the present invention. The motor control circuit 30 in FIG. 3 is similar to the motor control circuit 10, 20 in FIG. 1 or FIG. 2; therefore, those elements having similar functions are represented with the same symbols. The motor control circuit 30 includes a detect circuit 300, a bridge circuit 106 and a pulse width modulation source 306. The detect circuit 300 further includes a reference current generating module 301, a compare module 302 and a control module 304.

The power supply 100 provides a DC current into the bridge circuit 106 and the by-pass capacitor CVM1 stabilizes a voltage level of the power supply 100. In the detect circuit 300, the reference current generating module 301 is connected to the compare module 302. The compare module 302 receives a current from the output ports OUT1 and OUT2 and outputs to the control module 304. The control module 304 simultaneously receives a periodical square wave signal from the pulse width modulation source 306, so as to output a control result to the bridge circuit 106 and control the current outputted from the motor control circuit 30. There are four switches SW1, SW2, SW3 and SW4 of the bridge circuit 106, wherein the switches SW1 and SW3 form an up-bridge circuit and the switches SW2 and SW4 form a down-bridge circuit. Particularly, the switches SW1 and SW3 are realized by p-type MOS transistors, of which sources are coupled to the power supply 100 and gates are utilized for determining whether conducting or not according to the control result, and the switches SW2 and SW4 are realized by n-type MOS transistors, of which drains are correspondingly connected with drains of the switches SW3 and SW1, sources are coupled to a ground and gates are utilized for determining whether conducting or not according to the control result. In short, the up-bridge circuit and the down-bridge circuit determine whether they conduct or not according to the control result for modulating the current outputted from the motor control circuit 30.

Furthermore, the motor control circuit 30 sets the motor 108 in a start mode, a lock mode or a restart mode in order to modulate the current outputted from the motor control circuit 30. In detail, the reference current generating module 301 sets a predetermined value according to requirement of users. In this embodiment, the predetermined value is realized by a current, for example 1A. The reference current generating module 301 provides a preset current to the compare module 302, so as to compare differences between the predetermined value and the current outputted from the motor control circuit 30. When the current outputted from the motor control circuit 30 is larger than the predetermined value, the motor control circuit 30 complies with an operating condition. At this moment, the compare module 302 transmits the compare result to the control module 304, and the pulse width modulation source 306 simultaneously transmits a periodical square wave signal to the control module 304, which provides control module 304 a basis of how to output the control result. At last, the up-bridge circuit and the down-bridge circuit determine how much energy of the pulse width modulation source 306 should be outputted according to the control result, to limit the current outputted from the motor control circuit 30, and thus to prevent the current passing through the motor 108 from being large enough to burn down the motor 108.

In other words, when the motor 108 is in the start mode, the lock mode and the restart mode, there will be no Back Electro-Motive Force (BEMF) in those three modes to lead the motor into over current. The reference current generating module 301 is preset with a current limitation, and the comparator 302 compares the current outputted from the motor control circuit 30 with the current limitation, to determine whether or not to apply the technique of pulse width modulation for modulating the current passing through the motor 108. When the motor control circuit 30 has the outputted current larger than the current limitation, which means the motor 108 has potential over current, the pulse width modulation source 306 will modulate the duty cycle to limit the current outputted from the motor control circuit 30. For example, if the current limitation is 1.0 A and the current passing through the motor 108 is 1.2 A, the comparator 302 will immediately effectively cause the control module 304 to switch the duty cycle of the pulse width modulation source 306 to a lower value, such as from 100% to 50%, to correspondingly have the current outputted from the motor control circuit 30 reduce 0.6 A. In these circumstances, the current outputted from the motor control circuit 30 will not be larger than the current limitation, which prevents the motor 108 from burning up.

The motor control circuit 30 can dynamically detect the outputted current while it operates. As long as the outputted current is larger than the current limitation, the duty cycle of the pulse width modulation source 306 will switch to a lower value to make sure the current outputted from the motor control circuit 30 is smaller than the current limitation. If the outputted current passing through the motor 108 is 2.4 A, the duty cycle of the pulse width modulation source 306 will switch from 100% to 50% and have the corresponding outputted current 1.2 A, which is still larger than the current limitation. At this moment, the comparator 302 will effectively cause the control module 304, again, to switch the duty cycle of the pulse width modulation source 306 to another lower value, such as from 50% to 25%. In this situation, the corresponding current outputted from the motor control circuit 30 will reduce to 0.6 A, safely under the current limitation.

From the above description, the duty cycle of the pulse width modulation source 306 is merely utilized for demonstration, which will not narrow the scope of the present invention. For different users' requirements, the duty cycle of the pulse width modulation source 306 can be increased from a lower value to a higher value, or be periodically/randomly adjusted, so as to comply with other application fields of the motor 108. Additionally, when the outputted current is 2.4 A leading to a modulation of the duty cycle from 100% to 50%, and the resulting outputted current of 1.2 A, there might be little concern about burning up the motor 108 even though the current limitation is 1.0 A. Practically, there is no need for another modulation of the duty cycle, and only one modulation is needed. Thus a simple generator circuit for generating the pulse width modulation source signal that only needs to provide the duty cycle from 100% to 50% could be easily imagined.

As a result, the present invention is that when the motor control circuit 30 (or the motor 108) is in the start mode, the lock mode and the restart mode and detects the current outputted from the motor control circuit 30 being larger than the current limitation, the duty cycle of the pulse width modulation source 306 will be switched to a lower value, so as to limit the current outputted from the motor control circuit 30. Therefore, those skilled in the art can easily modify teachings of the present invention in order to apply the pulse width modulation source to different circuits, or to adjust an outputted signal from the control module to achieve the same purpose, so as to limit the current outputted from the motor control circuit.

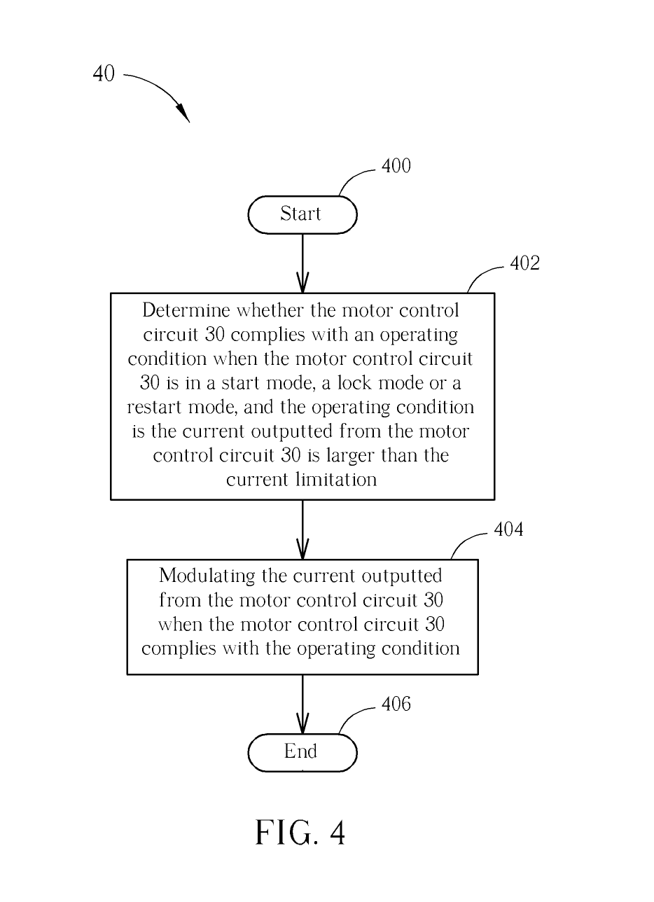

A circuit protection method utilized with the motor control circuit 30 of the present invention can be summarized in a protection circuit process 40, as shown in FIG. 4. The protection circuit process 40 comprises the following steps:

Step 400: Start.

Step 402: Determine whether the motor control circuit 30 complies with an operating condition when the motor control circuit 30 is in a start mode, a lock mode or a restart mode, and the operating condition is the current outputted from the motor control circuit 30 is larger than the current limitation.

Step 404: Modulating the current outputted from the motor control circuit 30 when the motor control circuit 30 complies with the operating condition.

Step 406: End.

Details of the protection circuit process 40 can be fully understood by the motor control circuit 30 shown in FIG. 3 as well as related description of the reference current generating circuit 301, the comparator 302 and the control module 304 in the detect circuit 300, the pulse width modulation source 306 and the bridge circuit 106, which are not described hereinafter.

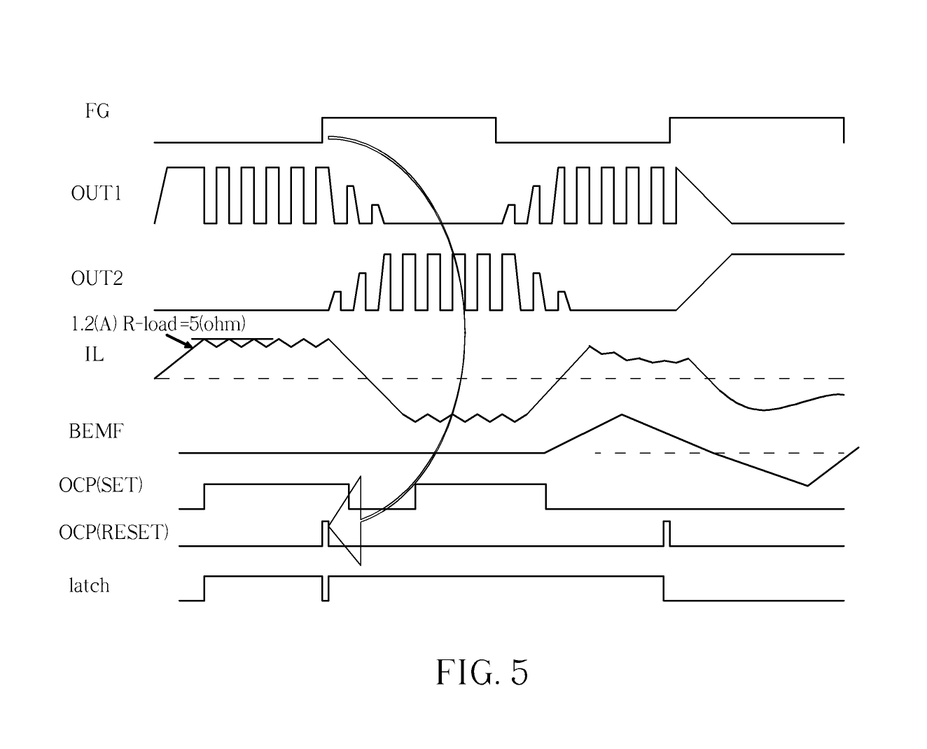

Please refer to FIG. 5, which illustrates a timing diagram of the motor control circuit 30 of the present invention. As shown in FIG. 5, if the power supply 100 can supply 12 V to the motor control circuit 30 and an equivalent resistance of the motor 108 is 5Ω, there will be a current with 2.4 A passing through the motor 108 if other resistors are neglected. When the motor 108 is in the start mode, the lock mode and the restart mode, and a load current IL passing through the motor 108 is larger than the current limitation, such as 1.2 A, a lock/restart module (not shown in figure) will transmit a current protection signal OCP to the control module 304, to dynamically switch the duty cycle of the pulse width modulation source 306, such as from 100% to 50%, according to the protection circuit process 40. The mentioned operation will lead the load current IL to oscillate in serration-shape away from being larger than the current limitation.

Furthermore, the current outputted from motor control circuit 30 has a current-direction-change represented by a rising-edge or a falling-edge of a periodical rotation signal FG. According to the rising-edge or the falling-edge of the rotation signal FG, the lock/restart module is triggered to transmit an over current protection reset signal OCPR to the control module 304, to make the protection circuit process 40 operate periodically. In this embodiment, the rising-edge of the periodical rotation signal FG is only for a demonstration, and a combination of the rising-edge as well as the falling-edge can work, too.

In other words, when the rising-edge of the rotation signal FG generates, a pulse signal within a short period will be generated to reset a latch, such as an SR-latch. If the current passing through the motor 108 is in over current after the current is reset by the latch, the duty cycle will be switched from 100% to 50%. Then, it forms a periodical situation that when the detect current module detects the current being larger than the current limitation, a lock signal will be generated to the SR-latch, and when the rising-edge of the rotation signal FG appears, the pulse signal within a short period will be generated to reset the latch. However, when the motor 108 successfully rotates for a while, the Back Electro-Motive Force (BEMF) will appear to decrease an input voltage of the power supply 100. At this moment, voltage differences between the terminals OUT1 and OUT2 becomes smaller, i.e. a smaller voltage is applied to the motor 108, and phenomenon of over current passing through the motor 108 will disappear. Although the rising-edge of the rotation signal FG reappears to reset the latch, the latch will not be triggered since the protection circuit process 40 no longer operates. The motor 108 can rotate normally to get away from the over current.

In addition, the motor control circuit 30 further provides another operating condition which is within a predetermined period after the motor control circuit 30 initiates, so as to modulate the current outputted from the motor control circuit 30. However, the mentioned operation stops after the predetermined period is over, in which there is no need for another detect circuit. In this embodiment, the control module 304 further includes a timer (not shown in figure). When the motor 108 is in the start mode, the lock mode and the restart mode, and is within the predetermined period, such as 5 seconds. The control module 304 does not need the comparison result outputted from the comparator 302. Instead, according to a driving signal of the timer, the control module 304 outputs the control result to the bridge circuit 106 to modulate the current outputted from the motor control circuit 30. That is to say, when the motor 108 is in the start mode, the lock mode and the restart mode and has experienced the predetermined period, the timer provides the driving signal to make the pulse width modulation source 306 correspondingly switch the duty cycle to a lower value, so as to limit the current outputted from the motor control circuit 30. Similarly, those skilled in the art can easily modify the teachings of the present invention to design a modulation of the current outputted from the motor control circuit based on experiencing different predetermined periods, which are also the scope of the present invention.

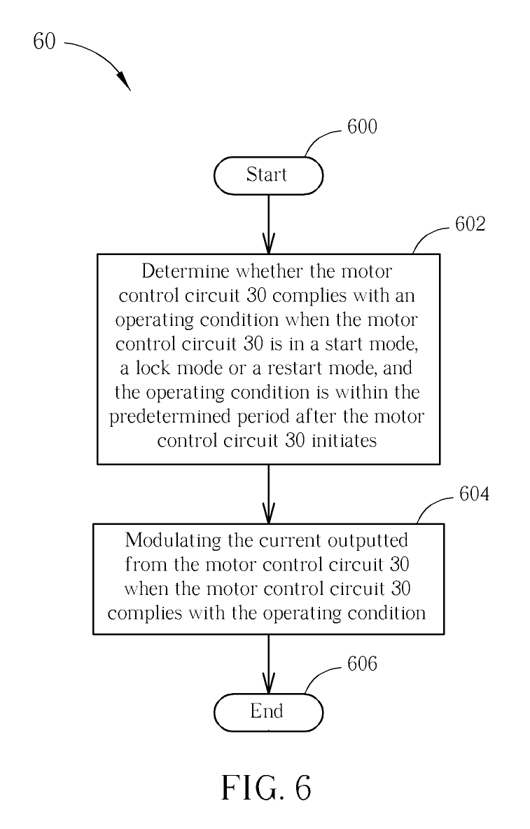

Furthermore, another circuit protection method utilized with the motor control circuit 30 of the present invention can be summarized in a protection circuit process 60, as shown in FIG. 6. The protection circuit process 60 comprises the following steps:

Step 600: Start.

Step 602: Determine whether the motor control circuit 30 complies with an operating condition when the motor control circuit 30 is in a start mode, a lock mode or a restart mode, and the operating condition is within the predetermined period after the motor control circuit 30 initiates.

Step 604: Modulating the current outputted from the motor control circuit 30 when the motor control circuit 30 complies with the operating condition.

Step 606: End.

The motor control circuit 30 also can combine the two operating conditions mentioned above (i.e. determining whether the motor control circuit 30 complies with the condition that the current outputted from the motor control circuit 30 is larger than the current limitation, or a period is longer than the predetermined period after the motor control circuit 30 initiates) to form different embodiments. Once the operating condition is met, the current outputted from the motor control circuit 30 will be detected and modulated to prevent over current from passing through the motor 108.

In summary, the motor control circuit and the protection circuit method of the present invention disclose that based on a current limitation set by a reference current generating module of a detect circuit, a comparison between the current limitation and a current outputted from the motor control circuit is made and transmitted to a bridge circuit through a control module, so as to switch a duty cycle of a pulse width modulation source and modulate the current outputted from the motor control circuit. Also, a timer provides another control signal to determine whether or not to switch the duty cycle of the pulse width modulation source, so as to limit the current outputted from the motor control circuit. Those embodiments are based on the application having Application No. 098109619 on 2009 Mar. 24, and named “Current Limit Control Method of DC Motor and Related Device and Circuit”, in order to avoid complex circuit designs as well as expansive semiconductor process, of which the motor control circuit can have wider application and protect the motor from being over heat while the motor normally rotates.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit protection method for a motor control circuit, the circuit protection method comprising:
determining whether the motor control circuit complies with an operating condition when the motor control circuit is in a start mode, a lock mode or a restart mode; and
modulating a current outputted from the motor control circuit when the motor control circuit complies with the operating condition.

2. The circuit protection method of claim 1, wherein the operating condition is the current outputted from the motor control circuit is larger than a predetermined value.

3. The circuit protection method of claim 2, further comprising modulating the current outputted from the motor control circuit to prevent the current from being larger than the predetermined value.

4. The circuit protection method of claim 1, wherein the operating condition is within a predetermined period after the motor control circuit initiates.

5. The circuit protection method of claim 1, wherein the motor control circuit comprises a detect circuit, the detect circuit comprising:
a reference current generating module, for generating a predetermined value;
a compare module, for comparing the current with the predetermined value to generate a comparison result; and
a control module, for generating a control signal to a bridge circuit according to the comparison result.

6. The circuit protection method of claim 5, further comprising receiving a partial energy from a pulse width modulation source by the control module according to the comparison result.

7. The circuit protection method of claim 5, wherein the bridge circuit comprises an up-bridge circuit and a down-bridge circuit turned on or off according to the control signal, so as to modulate the current outputted from the motor control circuit.

8. The circuit protection method of claim 7, wherein the up-bridge circuit comprises an input port coupled to a power supply, an output port and a controlled port for connecting a voltage source received by the input port with the output port according to the control signal outputted from the control module; and the down-bridge circuit of the bridge circuit comprises an input port coupled to the output port of the up-bridge circuit, an output port coupled to the ground, and a controlled port for connecting a voltage source received by the input port with the output port according to the control signal outputted from the control module.

9. The circuit protection method of claim 8, wherein the motor is coupled between the output port of the up-bridge circuit and the output port of the down-bridge circuit.

10. The circuit protection method of claim 9, further comprising modulating the current passing through the motor when the motor is in the start mode, the lock mode or the restart mode.

11. A motor control circuit for determining whether the motor control circuit complies with an operating condition when the motor control circuit is in a start mode, a lock mode or a restart mode, comprising:
a detect circuit coupled to a motor, for detecting a current outputted from the motor control circuit and modulating a current outputted from the motor control circuit when the motor control circuit complies with the operating condition;
a bridge circuit coupled to an output port of the detect circuit; and
a pulse width modulation source coupled to an input port of the detect circuit.

12. The motor control circuit of claim 11, wherein the operating condition is the current outputted from the motor control circuit is larger than a predetermined value.

13. The motor control circuit of claim 12, wherein the pulse width modulation source modulates the current outputted from the motor control circuit to prevent the current from being larger than the predetermined value.

14. The motor control circuit of claim 11, wherein the operating condition is within a predetermined period after the motor control circuit initiates.

15. The motor control circuit of claim 11, wherein the detect circuit further comprises:
a reference current generating module, for generating a predetermined value;
a compare module, for comparing the current with the predetermined value to generate a comparison result; and
a control module, for generating a control signal to a bridge circuit according to the comparison result.

16. The motor control circuit of claim 15, wherein the control module receives a partial energy from the pulse width modulation source according to the comparison result.

17. The motor control circuit of claim 15, wherein the bridge circuit comprises an up-bridge circuit and a down-bridge circuit turned on or off according to the control signal, so as to modulate the current outputted from the motor control circuit.

18. The motor control circuit of claim 17, wherein the up-bridge circuit comprises an input port coupled to a power supply, an output port and a controlled port for connecting a voltage source received by the input port with the output port according to the control signal outputted from the control module; and the down-bridge circuit of the bridge circuit comprises an input port coupled to the output port of the up-bridge circuit, an output port coupled to the ground, and a controlled port for connecting a voltage source received by the input port with the output port according to the control signal outputted from the control module.

19. The motor control circuit of claim 18, wherein the motor is coupled between the output port of the up-bridge circuit and the output port of the down-bridge circuit.

20. The motor control circuit of claim 18, wherein the pulse width modulation source modulates the current passing through the motor when the motor is in the start mode, the lock mode or the restart mode.
